(19) United States
(12) Patent Application Publication
(10) Pub. No.: US 2022/0171183 A1
(43) Pub. Date: Jun. 2, 2022

(54) CAMERA DEVICE

(71) Applicant: Chicony Electronics Co., Ltd., New Taipei City (TW)

(72) Inventors: Cheng-Lung Hsu, New Taipei City (TW); Yen-Ting Liu, New Taipei City (TW)

(21) Appl. No.: 17/362,208

(22) Filed: Jun. 29, 2021

(30) Foreign Application Priority Data
Nov. 27, 2020 (TW) 109141928

(51) Int. Cl. G02B 27/00; G02B 7/02

(52) U.S. Cl. CPC G02B 27/0006; G02B 7/02

(57) ABSTRACT

A camera device includes an outer cap, a lens, a circuit board, and a dustproof sheet. The outer cap includes an axle hole, a first end, and a second end axially opposite to the first end. The lens is disposed on the first end of the outer cap. The circuit board is disposed on the second end of the outer cap. The circuit board includes an inner surface located in the axle hole. The inner surface has an optical sensing area and a non-optical sensing area. An optical sensing module is disposed on the optical sensing area to correspond to the lens. The dustproof sheet is disposed in the axle hole of the outer cap. The dustproof sheet covers the non-optical sensing area of the inner surface of the circuit board.

### CROSS-REFERENCE TO RELATED APPLICATION

This non-provisional application claims priority under 35 U.S.C. § 119(a) to Patent Application No. 109141928 filed in Taiwan, R.O.C. on Nov. 27, 2020, the entire contents of which are hereby incorporated by reference.

### BACKGROUND

### Technical Field

The instant disclosure relates to an optical device, in particular, to a camera device.

### Related Art

Along with developments of technology, camera devices are widely used in different fields, such as personal computer products, automobiles, and medical sciences, for capturing an external image. For example, a camera device may be installed on the car to capture the image outside the car for driving assistance.

### SUMMARY

For most of the camera devices known to the inventor(s), optical sensing elements are used to perform sensing to obtain the external images. In order to ensure the image quality, the optical sensing element is disposed in the housing of the camera device. Under such configuration, dusts outside the camera device can be prevented from entering into the housing to attach on the optical sensing element. However, during the assembling or operation of the camera device, dusts on the components inside the camera device would be raised to affect the optical sensing effect of the optical sensing element and the image quality.

In view of this, in one embodiment, a camera device is provided. The camera device comprises an outer cap, a lens, a circuit board, and a dustproof sheet. The outer cap comprises an axle hole, a first end, and a second end axially opposite to the first end. The lens is disposed on the first end of the outer cap. The circuit board is disposed on the second end of the outer cap. The circuit board comprises an inner surface located in the axle hole. The inner surface has an optical sensing area and a non-optical sensing area. An optical sensing module is disposed on the optical sensing area to correspond to the lens. The dustproof sheet is disposed in the axle hole of the outer cap. The dustproof sheet covers the non-optical sensing area of the inner surface of the circuit board.

As above, according to the camera device of one or some embodiments of the instant disclosure, since the dustproof sheet is covered on the non-optical sensing area of the inner surface of the circuit board, dusts on the surfaces of components (e.g., electronic components or wirings) in the non-optical sensing area can be prevented from attaching to the optical sensing module, thereby ensuring the image quality of the optical sensing module and further enhancing the dustproof and waterproof functions for the circuit board.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of a camera device according to a first embodiment of the instant disclosure;

FIG. 2 illustrates an exploded view of the camera device of the first embodiment;

FIG. 3 illustrates a cross-sectional view of the camera device of the first embodiment;

FIG. 4 illustrates a cross-sectional view of a camera device according to a second embodiment of the instant disclosure;

FIG. 5 illustrates a cross-sectional view of a camera device according to a third embodiment of the instant disclosure; and

FIG. 6 illustrates a cross-sectional view of a camera device according to a fourth embodiment of the instant disclosure.

### DETAILED DESCRIPTION

Embodiments are provided for facilitating the descriptions of the instant disclosure. However, the embodiments are provided as examples for illustrative purpose, but not a limitation to the instant disclosure. In all the figures, same reference numbers designate identical or similar elements.

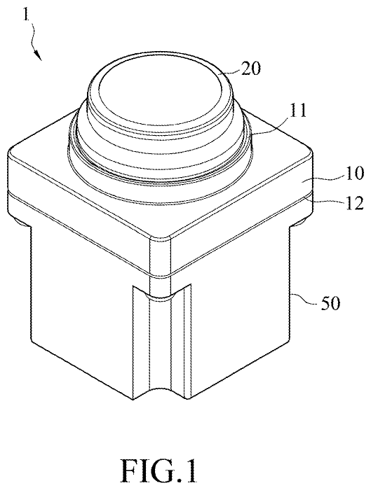

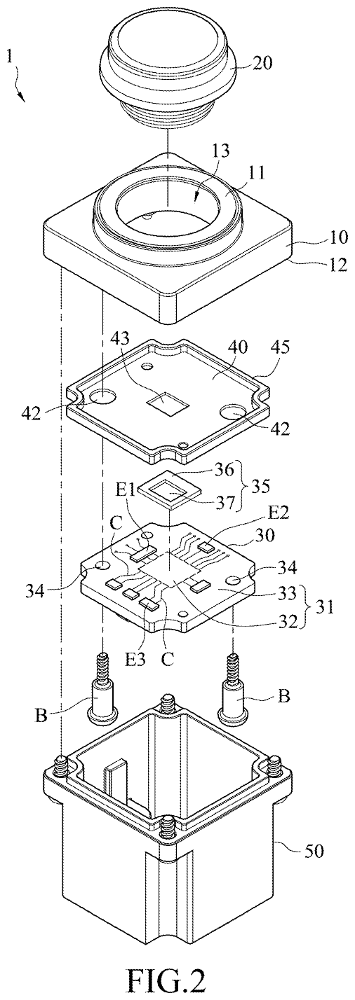

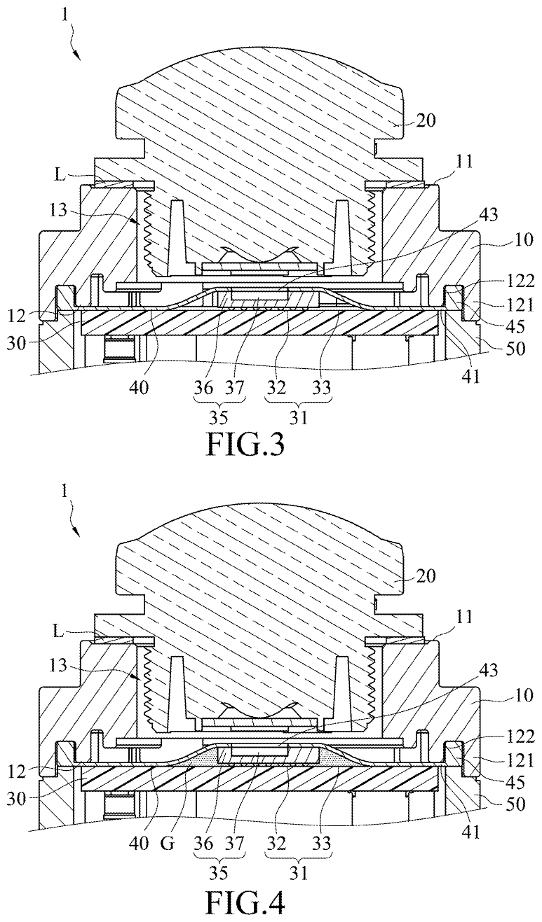

FIG. 1 illustrates a perspective view of a camera device 1 according to a first embodiment of the instant disclosure. FIG. 2 illustrates an exploded view of the camera device 1 of the first embodiment. FIG. 3 illustrates a cross-sectional view of the camera device 1 of the first embodiment. As shown in FIGS. 1 to 3, in this embodiment, the camera device 1 comprises an outer cap 10, a lens 20, a circuit board 30, and a dustproof sheet 40. In some embodiments, the camera device 1 may be utilized in different electronic devices for capturing images around the electronic devices. For example, the camera device 1 may be utilized in automotive products (e.g., dashcams, backup camera systems, or surrounding view systems), mobile devices (e.g., smart phones, tablet computers, or notebook computers), cameras, or other electronic devices.

As shown in FIGS. 1 to 3, the outer cap 10 comprises an axle hole 13, a first end 11, and a second end 12 axially opposite to the first end 11. In this embodiment, the axle hole 13 defines through the first end 11 and the second end 12 of the outer cap 10, so that the outer cap 10 is of a hollowed ring shape. The shape of the axle hole 13 may be, but not limited to, round, elliptical, square, or other irregular shapes.

As shown in FIGS. 1 to 3, the lens 20 is disposed on the first end 11 of the outer cap 10 to cover one of two ends of the axle hole 13 correspondingly. In this embodiment, the lens 20 is fixed to the first end 11 of the outer cap 10 by adhering, and a portion of the lens 20 further extends into the axle hole 13. For example, during the assembling of the lens 20, a light curing adhering layer is provided around the first end 11 of the outer cap 10. After the lens 20 is placed on the light curing adhering layer and the focal length of the lens is adjusted, certain light beams may be applied to illuminate the light curing adhering layer (for instance, in the case that the light curing adhering layer is an ultraviolet light curing adhering layer, ultraviolet light beams are applied to illuminate the light curing adhering layer), so that the light curing adhering layer is pre-cured to prevent the shifting of the lens 20. Last, a baking procedure is applied to the lens 20 and the pre-cured light curing adhering layer, so that the light curing adhering layer is heat-cured to form a cured glue layer L so as to fix the lens 20 on the first end 11 of the outer cap 10, but embodiments are not limited thereto. In some embodiments, the lens 20 may be adhered on the outer cap 10 with common glues.

In some embodiments, the lens 20 may be fixed on the first end 11 of the outer cap 10 through engaging, locking, soldering, or other manners.

As shown in FIGS. 1 to 3, the circuit board 30 is disposed on the second end 12 of the outer cap 10 to cover the other end of the axle hole 13. The circuit board 30 comprises an inner surface 31 located in the axle hole 13. The inner surface 31 has an optical sensing area 32 and a non-optical sensing area 33. An optical sensing module 35 is disposed on the optical sensing area 32 to correspond to the lens 20. Therefore, after an external light beam enters into the camera device 1 from the lens 20, the external light beam passes through the axle hole 13 and is focused on the optical sensing module 35, thus allowing the optical sensing module 35 to perform sensing to obtain images. The non-optical sensing area 33 may be regions of the inner surface 31 other than the optical sensing area 32. For example, in this embodiment, the optical sensing area 32 is at a middle portion of the inner surface 31 of the circuit board 30, and the non-optical sensing area 33 is an area other than the optical sensing area 32 and surrounds the optical sensing area 32. The non-optical sensing area 33 may be provided with conductive wirings C and electronic components E1-E3 (e.g., microprocessor, resistors, or capacitors).

In some embodiments, specifically, the optical sensing module 35 may be a charge-coupled device (CCD), a complementary metal-oxide semiconductor (CMOS), or a CMOS active pixel sensor.

As shown in FIGS. 1 to 3, the dustproof sheet 40 is disposed in the axle hole 13 of the outer cap 10, and the dustproof sheet 40 covers the non-optical sensing area 33 of the inner surface 31 of the circuit board 30. Accordingly, the dustproof sheet 40 prevents the dusts inside the lens 20 to affect the optical sensing module 35; that is, in this embodiment, during assembling the camera device 1 to other devices or during the operation of the camera device 1, the dustproof sheet 40 prevents the dusts on the components (for example, the conductive wirings C and the electronic components E1-E3) of the non-optical sensing area 33 of the inner surface 31 from being raised. Hence, dusts in the camera device 1 can be prevented from attaching to the optical sensing module 35, thereby ensuring the image quality of the optical sensing module 35. Moreover, the conductive wirings C and the electronic components E1-E3 on the circuit board 30 are shielded by the dustproof sheet 40, thus further enhancing the dustproof and waterproof functions for the circuit board 30. Moreover, the dustproof sheet 40 can be in contact with the circuit board 30, allowing the heat generated by the circuit board 30 to be conducted outward through the dustproof sheet 40 to perform the heat dissipation function for the circuit board 30.

In some embodiments, the dustproof sheet 40 may be a sheet made of plastics, rubber, silicone rubbers, papers, or the like.

In some embodiments, the dustproof sheet 40 may be fixed on the non-optical sensing area 33 of the inner surface 31 of the circuit board 30. For example, the dustproof sheet 40 may be fixed on the non-optical sensing area 33 through engaging, limiting, locking, adhering, or the like. Therefore, shifting of the dustproof sheet 40 can be prevented to affect the waterproof and dustproof functions.

As above, as shown in FIGS. 1 to 3, in this embodiment, the circuit board 30 and the dustproof sheet 40 are locked to the second end 12 of the outer cap 10. Specifically, in one or some embodiments, the circuit board 30 has at least one first assembling portion 34 (in this embodiment, the circuit board 30 has two first assembling portions 34, but the number of the first assembling portions 34 are not limited thereto). The two first assembling portions 34 may be lock holes or through holes, respectively, and the two first assembling portions 34 are adjacent to two opposite corners of the circuit board 30. The dustproof sheet 40 has at least one second assembling portion 42 (in this embodiment, the dustproof sheet 40 has two second assembling portions 42, but the number of the second assembling portions 42 are not limited thereto). The two second assembling portions 42 may be lock holes or through holes, respectively, and the two assembling portions 42 are adjacent to two opposite corners of the dustproof sheet 40. The two first assembling portions 34 respectively correspond to the two second assembling portions 42, and the two first assembling portions 34 and the two second assembling portions 42 are together fixed on the second end 12 of the outer cap 10. For example, in this embodiment, during the assembling process of the circuit board 30 and the dustproof sheet 40, two bolts B are provided to pass through the two first assembling portions 34 and the two second assembling portions 42 and to lock to the second end 12 of the outer cap 10 correspondingly, so that the circuit board 30 and the dustproof sheet 40 are together locked to the second end 12 of the outer cap 10, but embodiments are not limited thereto. In some embodiments, the circuit board 30 and the dustproof sheet 40 may be fixed on the outer cap 10 through different fixing manners.

Further, as shown in FIGS. 1 to 3, in this embodiment, the optical sensing module 35 comprises an outer frame 36 and an optical sensing element 37 in the outer frame 36, and the optical sensing element 37 corresponds to the lens 20. The dustproof sheet 40 comprises a through hole 43, and the through hole 43 corresponds to the optical sensing element 37, so that the optical sensing element 37 is exposed from the dustproof sheet 40 through the through hole 43. Hence, the optical sensing element 37 can detect the light beam entering from the lens 20. Moreover, the dustproof sheet 40 may be a flexible sheet (e.g., a rubber sheet or a silicone rubber sheet) and abuts on the outer frame 36. Specifically, in one embodiment, the size of the through hole 43 of the dustproof sheet 40 may be approximately the same as the size of the optical sensing element 37 (e.g., the size of the through hole 43 may be equal to or slightly greater than the size of the optical sensing element 37). When the dustproof sheet 40 covers the circuit board 30 to allow the through hole 43 to correspond to the optical sensing element 37, owing to the flexibility of the dustproof sheet 40, portions of the dustproof sheet 40 adjacent to the through hole 43 abut on the outer frame 36, and other portions of the dustproof sheet 40 cover the non-optical sensing area 33 of the circuit board 30, thus preventing the dusts on the outer frame 36 from attaching on the optical sensing element 37.

Alternatively, as shown in FIG. 4, a cross-sectional view of a camera device according to a second embodiment of the instant disclosure is illustrated. In this embodiment, a glue layer G is applied to fix the dustproof sheet 40 and the non-optical sensing area 33 of the circuit board 30. Accordingly, the glue layer G not only achieves the fixation between the dustproof sheet 40 and the circuit board 30, but also further prevents the dusts on the surfaces of the components of the non-optical sensing area 33 from attaching on the optical sensing module 35. In some embodiments, the glue layer G may be a thermal conductive glue layer or a thermal conductive paste layer, so that heat of the circuit board 30 can be conducted outward through the glue layer G to perform heat dissipation function for the circuit board 30.

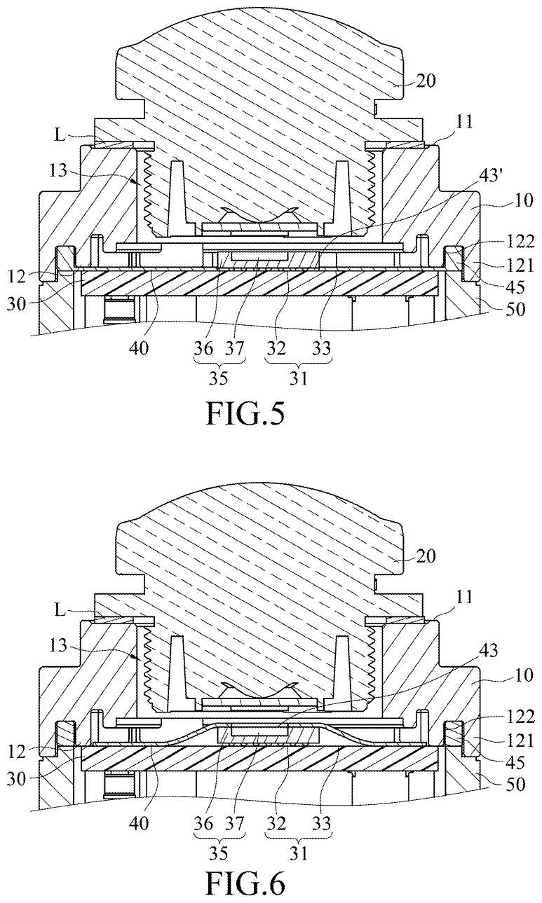

Alternatively, as shown in FIG. 5, a cross-sectional view of a camera device according to a third embodiments of the instant disclosure is illustrated. In this embodiment, the size of the through hole 43′ of the dustproof sheet 40 is greater than the size of the entire optical sensing module 35. Accordingly, when the dustproof sheet 40 covers the circuit board 30 to allow the through hole 43′ to correspond to the optical sensing module 35, the entire optical sensing module 35 is located in the through hole 43′ so as to be exposed from the dustproof sheet 40. That is, in this embodiment, the optical sensing element 35 is not covered by the dustproof sheet 40 so as to detect the light beam entering from the lens 20. Moreover, under such configuration, the dustproof sheet 40 can be flatly covered on the non-optical sensing area 33 of the inner surface 31 of the circuit board 30.

As shown in FIGS. 1 to 3, in this embodiment, the camera device 1 further comprises a base member 50. The second end 12 of the outer cap 10 has an outer periphery portion 121. The outer periphery portion 121 is not fixed with the circuit board 30. The outer periphery portion 121 is fixed on the base member 50, an annular groove 122 is between the base member 50 and the outer periphery portion 121, and a sealing ring 45 is in the annular groove 122. Accordingly, the outer cap 10 and the base member 50 form a closed space to prevent dust outside the camera device 1 from entering into the camera device 1 to affect the optical sensing module 35. In some embodiments, the annular groove 122 may be recessed from the second end 12 of the outer cap 10 (as shown in FIG. 3) or recessed from the base member 50, but embodiments are not limited thereto.

In some embodiments, the sealing ring 45 may be made of plastics, rubbers, silicone rubbers, or the like.

Further, as shown in FIGS. 1 to 3, in this embodiment, the dustproof sheet 40 and the sealing ring 45 may be integrally formed as a one-piece member. For example, the dustproof sheet 40 and the sealing ring 45 may be both made of rubbers or silicone rubbers and are manufactured by injection molding. Accordingly, the dustproof sheet 40 and the sealing ring 45 can be manufactured and assembled along with each other, thus reducing the manufacturing steps of the camera device 1 and reducing the production costs of the camera device 1. Moreover, in one embodiment, an annular connection portion 41 is between the dustproof sheet 40 and the sealing ring 45. The second end 12 of the outer cap 10 abuts on the annular connection portion 41, so that the dustproof sheet 40 can be firmly covered on the non-optical sensing area 33 to improve the external dustproof effect.

Alternatively, as shown in FIG. 6, a cross-sectional view of a camera device according to a fourth embodiment of the instant disclosure is illustrated. In this embodiment, the dustproof sheet 40 and the sealing ring 45 are separated elements. Therefore, according to different user requirements, the dustproof sheet 40 and the sealing ring 45 can be made of different materials.

As above, according to the camera device of one or some embodiments of the instant disclosure, since the dustproof sheet is covered on the non-optical sensing area of the inner surface of the circuit board, dusts on the surfaces of components (e.g., electronic components or wirings) in the non-optical sensing area can be prevented from attaching to the optical sensing module, thereby ensuring the image quality of the optical sensing module and further enhancing the dustproof and waterproof functions for the circuit board.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A camera device comprising:
an outer cap comprising an axle hole, a first end, and a second end axially opposite to the first end;
a lens disposed on the first end of the outer cap;
a circuit board disposed on the second end of the outer cap, wherein the circuit board comprises an inner surface located in the axle hole, the inner surface has an optical sensing area, and a non-optical sensing area, and an optical sensing module is disposed on the optical sensing area to correspond to the lens; and
a dustproof sheet disposed in the axle hole of the outer cap, wherein the dustproof sheet covers the non-optical sensing area of the inner surface of the circuit board.

2. The camera device according to claim 1, further comprising a base member, wherein the second end of the outer cap has an outer periphery portion, and the outer periphery portion is fixed on the base member, an annular groove is between the base member and the outer periphery portion, and a sealing ring is in the annular groove.

3. The camera device according to claim 2, wherein the dustproof sheet and the sealing ring are integrally formed as a one-piece member.

4. The camera device according to claim 3, wherein an annular connection portion is between the dustproof sheet and the sealing ring, and the second end of the outer cap abuts on the annular connection portion.

5. The camera device according to claim 1, wherein the dustproof sheet is fixed on the non-optical sensing area.

6. The camera device according to claim 5, wherein the dustproof sheet and the non-optical sensing area are fixed to each other through a glue layer.

7. The camera device according to claim 5, wherein the circuit board has a first assembling portion, the dustproof sheet has a second assembling portion, the first assembling portion and the second correspond to each other, and the first assembling portion and the second assembling portion are fixed on the second end of the outer cap.

8. The camera device according to claim 1, wherein the optical sensing module comprises an outer frame and an optical sensing element in the outer frame, wherein the dustproof sheet has a through hole, and the through hole corresponds to the optical sensing element so as to expose the optical sensing element.

9. The camera device according to claim 8, wherein the dustproof sheet is a flexible sheet and abuts on the outer frame.

10. The camera device according to claim 1, wherein the dustproof sheet has a through hole, and the optical sensing module located is in the through hole.
